(19) United States
(12) Patent Application Publication
(10) Pub. No.: US 2011/0185911 A1
(43) Pub. Date: Aug. 4, 2011

(54) Filtering permeable thermoformed container for beverage-making products with a flat rim

(76) Inventor: Gino Rapparini, Bologna (IT)

(21) Appl. No.: 13/066,158

(22) Filed: Apr. 7, 2011

(30) Foreign Application Priority Data
Oct. 21, 2009 (IT) BO 2009 A 679
Apr. 9, 2010 (IT) BO 2010 A 000219

(51) Int. Cl. A47J 31/06

(52) U.S. Cl. 99/295

(57) ABSTRACT

An improved filtering permeable thermoformed container is provided which can be formed from a flat film into a shape of a cup for containing water-soluble or brewing products for making beverages wherein an advantageously shaped reinforcement ring supports a rim of the film body and a membrane lid in a rigid manner to facilitate the lid being pierced.

### FIELD OF THE INVENTION

The present invention relates to the packaging field and in particular to a filtering permeable thermoformed container for beverage-making products which can be used for single serve brewing machines.

### RELATED APPLICATIONS

This application is related to Italian application BO 2009 A 679 filed by applicant on Oct. 21, 2009, and Italian application BO 2010 A 000219 filed by applicant on Apr. 9, 2010.

### BACKGROUND OF THE INVENTION

There are known filtering permeable containers for making beverages for single serve brewing machines, obtained by thermoforming from a flat film and closed with a filter paper membrane. These containers may have an impermeable cup made of stiff plastic which contains a cup-shaped filter inside. The filter may be made of paper or polymer material and generally has a flat bottom wall spaced from the flat bottom portion of the cup so as to provide an area for receiving a brewed beverage. The plastic cup has a cover which may be pierced by a tube to inject heated liquid into the filter. When the liquid permeates through the filter wall, the beverage is collected in the bottom of the cup and an outlet probe is used to pierce the bottom of the cup to extract the beverage.

Typical of the prior art container which the present invention is designed to improve on, is disclosed in U.S. Patent Application Publication No. 2005/0051478 to Karanikos and Rossi. FIG. 1 from the Karanikos patent publication illustrates this type of cup, and is shown within at FIG. 15.

Italian patent application BO 2009 A 679 filed by applicant on Oct. 21, 2009 relates to the manufacture of containers for beverage-making products. Existing filters are not sufficiently rigid to be used directly as containers in the known dispensing machines and are therefore pre-packed inside a stiff plastic container and closed with barrier-film membranes or inserted inside a reusable plastic molded adaptor, usually supplied with known dispensing machines.

In addition, many existing containers utilize excessive material by using inner and outer cups for the necessary functions to be performed by the container, and accordingly fail to meet ecological standards for biodegradability. For example, as described above, many containers utilize a stiff plastic outer cup which requires piercing of the bottom of the cup to permit fluid to be released from the cup.

Furthermore, use of biodegradable and/or compostable materials such as PLA, Mater Bi or blends of these and other resins, entail specific challenges for the production and design of a container. For example, use of biodegradable and/or compostable material can impose design challenges which, without the benefit of the present invention, can result in the use of excessive and expensive material.

### OBJECTS OF THE INVENTION

It is therefore one objective of the present invention to provide a container that would solve the problems and improve containers currently used in the industry, such as those that are discussed above.

An object of this invention is to provide an improved container with a reinforced flat rim for use with existing machines that is stiff enough to support the piercing of the injecting needle and the pressure of the sealing gasket to be used with known common domestic dispensing machines and in the more sophisticated professional ones, without using complicated adaptors.

It is a further object of the invention to provide a container with a reinforced flat rim which does not utilize a hard outer cup surrounding the filter of the container which imposes additional requirements for the disposal of used containers and to utilize ecological materials and to avoid use of excess material to perform the functions of the container.

It is a further object of the invention to provide a container which does not utilize material forming a hard outer cup surrounding the filter of the container and which requires piercing of the bottom portion of a hard outer cup to permit the release of brewed product and which permits the release of brewed product from the container through the container filter so the brewed product can flow downward by gravity to exit a brewing machine and be readily available to a user.

It is a further object of the invention to provide a container having a reinforced rim which supports a closing membrane that allows piercing by an injection needle and improved handling compared to conventional filter paper coffee pods, and facilitates placement of the container in a single serve brewing machine before the brewing process, and facilitates safe removal of the container after the brewing process when the container may still be hot and wet.

It is also an object of the invention to provide a container with a reinforced flat rim which can be used in existing brewing machines and machines having only a single needle or other device for piercing a portion of the top of the container, which needles can infect hot water into the container for brewing. The brewed beverage may then pass through the filter and funnel into drinking receptacles without the need for a second (2nd) needle to puncture the bottom of an outer container.

It is also an object of the invention to provide a container which can be used in existing brewing machines having a sealing gasket or other device to avoid the escape of hot water injected into the container by a needle or other device through an aperture in the container which may be created by a needle.

It is a further object of the invention to provide a container having a top lid surface with sufficient tension to permit piercing of the top lid surface by a needle of a brewing machine used for injecting hot water into the container.

It is a further object of the invention to provide a container having a stiff and flat membrane which can be readily penetrated by a needle in existing brewing machines where the container has a top lid surface with sufficient tension to permit a mating gasket surface of a brewing machine to securely grip and support the top lid surface of the container and prevent the escape of hot water injected into the container by a needle or other device through an aperture in the container created by the needle.

It is also an object of the invention to provide a container capable of being fabricated from biodegradable materials, and to meet biodegradability and/or compostability standards for a single serve beverage container.

It is an object of the invention to provide a container having a reinforced rim which avoids the use of complicated adaptors or the introduction of expensive and non-ecological rigid plastic containers.

It is a further object of the invention to provide a container which can be readily removed from a brewing machine after use.

It is a further object of the invention to provide a container which facilitates correct positioning of container in a single serve brewing machine.

It is an object of the invention to provide a container which can utilize non-aluminum based materials for a top membrane and has a container body with pleated portions, whereby the container body can be stiffened to be substantially self-supporting with an improved aesthetic appearance for the container body.

These and other objectives and advantages of the present invention will become evident from the description and drawings that follow.

### SUMMARY OF THE INVENTION

A filtering container is provided for water soluble beverage making products. A water permeable container body is thermoformed from a flat film providing container space to receive a water soluble brewing product. The container body has a flat rim extending around the opening of the container. A reinforcement with a horizontal portion that mates with and reinforces the flat rim of the container body with a substantially flat surface forms a complementary support. The flat rim of the container is connected to membrane that closes the opening of the container and maintains the membrane in a substantially stiff manner.

In a preferred embodiment, the container body includes a reinforced flat rim extending around the opening of the container. In one embodiment, a reinforcing ring with a horizontal portion mates with and supports the flat rim of the container body with a substantially flat top surface which forms a complementary ring. The flat rim of the container body is connected to membrane that closes the opening of the container and maintains the membrane in a substantially stiff manner.

The flat rim reinforcement ring supports the container body providing a container space which can receive a product such as ground coffee. In one embodiment, the reinforcement ring has a substantially flat horizontal top surface which forms a ring rim which is connected to the container membrane and maintains the position and shape of the membrane.

In various embodiments of a filtering container according to the invention, the container body, the reinforcement ring and membrane can be fabricated using biodegradable material.

In another embodiment, the container body includes a flat top rim which is disposed between the top horizontal portion of a reinforcing ring and a bottom surface of the membrane. In an alternative embodiment the reinforcement ring is heat sealed and integral to the flat ring rim.

In an alternative embodiment, the membrane is connected to the top surface of the reinforcement ring and the container body is connected to a bottom surface of the ring.

It is also possible to provide a container according to the invention with a reinforced rim having a membrane that is folded around an outer edge of the flat top rim of the container body and is connected to a bottom surface flat rim. In another embodiment, the membrane is folded around the outside edge of the reinforcing ring.

In a further conceived variation of a container according to the invention, the container body includes pleated portions whereby the container body is stiffened so as to be substantially self-supporting. A container body can also include a sleeve which provides a lesser permeable portion of the container body. In addition, the container body can include a spreader disc at a bottom center area of the container body. The spreader disc can cooperate with the container body to provide a lesser permeable portion of the container body. The spreader disc can be provided on an outside surface of the container body and be removable by a user. In addition, the spreader disc can include an aperture disposed at a center area of the disc.

### BRIEF DESCRIPTION OF THE DRAWINGS

Preferred embodiments of the inventive devices are illustrated in the drawings and are described below, though not necessarily to scale. The invention is explained in detail, referring to the figures of the drawings, enclosed as non-limiting examples.

FIG. 1 illustrates a perspective view of an embodiment of a container body according to the invention.

FIG. 2 illustrates a side cross-section perspective view of an embodiment of a container body with a rim supported by a reinforcement ring according to the invention.

FIG. 3 illustrates a side cross-sectional view of an embodiment of a container having a closing membrane lid and being filled with a brewing material according to the invention.

FIG. 4 illustrates a perspective view of an embodiment of a container with closing membrane according to the invention.

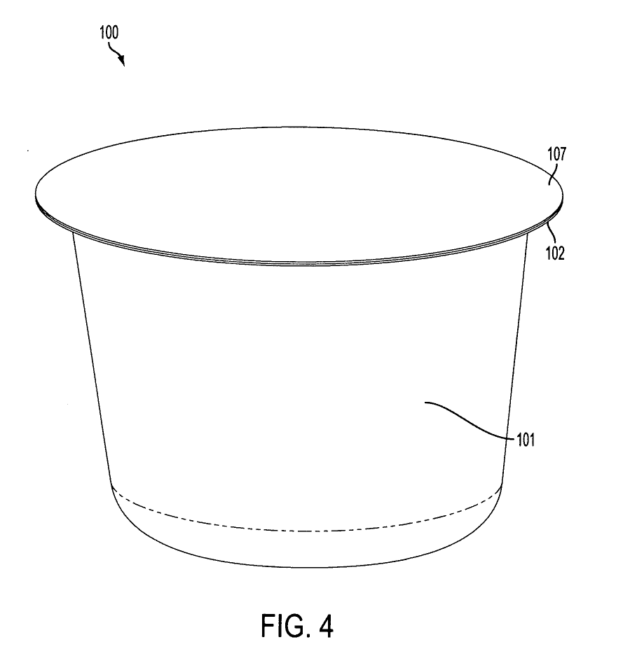

FIG. 5 illustrates a side cross-sectional view of an embodiment of a container according to the invention, such as shown in FIG. 3, with portions of machine components for a brewing machine for which the container is adapted for use with a needle poised to pierce the top membrane cover.

FIG. 6 illustrates a side cross-sectional view of an embodiment of a container according to the invention, such as shown in FIG. 5, with portions of machine components for a brewing machine for which the container is adapted for use wherein the needle has pierced the membrane.

FIG. 7 illustrates a vertical cross section view of a portion of a brewing machine and an embodiment of a container placed therein according to the invention.

FIG. 8 illustrates a side cross-sectional view of another embodiment of a container according to the invention, and containing a brewing material.

FIG. 9 illustrates a side cross-sectional view of another embodiment of a container according to the invention, and containing a brewing material.

FIG. 10 illustrates a side cross-sectional view of another embodiment of a container according to the invention, and containing a brewing material.

FIG. 11 illustrates a perspective view of a container body for an embodiment of a container according to the invention.

FIG. 12 illustrates a cross sectional side view of an embodiment of a container according to the invention.

FIG. 13 illustrates a side cross-sectional view of an embodiment of a container according to the invention with portions of machine components for a brewing machine for which the container is adapted for use.

FIG. 14 illustrates an alternative embodiment of a container body according to the invention, with FIG. 14a showing a bottom cross-section view of a lower portion of the container body, and FIG. 14b showing a cross-section view of the upper portion of the container body.

FIG. 15 illustrates a prior art solution.

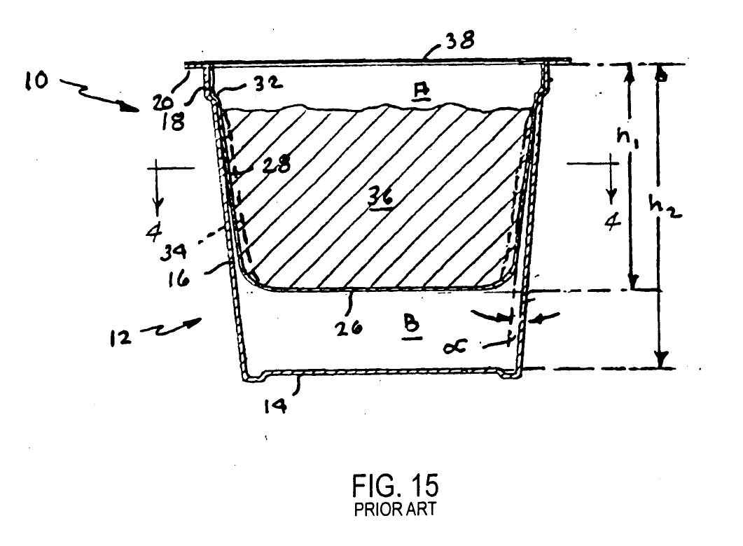

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION

A detailed description of a filtering permeable container which can be used with a single server brewing machine is provided below. In addition, several specific embodiments are provided as examples of the devices which one of ordinary skill in the art may apply these teachings to address specific problems and to illustrate the benefits and improvements of the system over known solutions.

Italian applications BO 2009 A 679, BO 2010 A 000219, and PCT application PCT/EP2010/006389, of which applicant is an inventor, are relevant to the present invention.

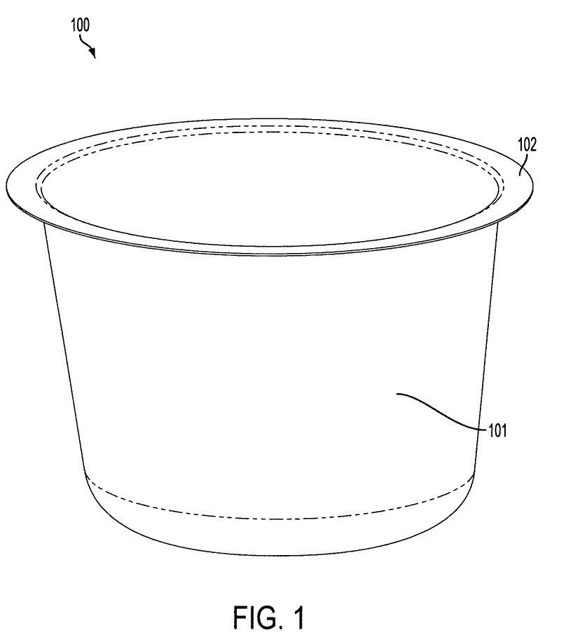

FIG. 1 illustrates an embodiment of a container 100 according to the invention. The container 100 includes a container body 101 made of a thermoformed filtering permeable material. An embodiment of the container body includes a flat top rim 102. Through the top opening of the container body 101, a brewing product can be deposited into the interior space of the container 100.

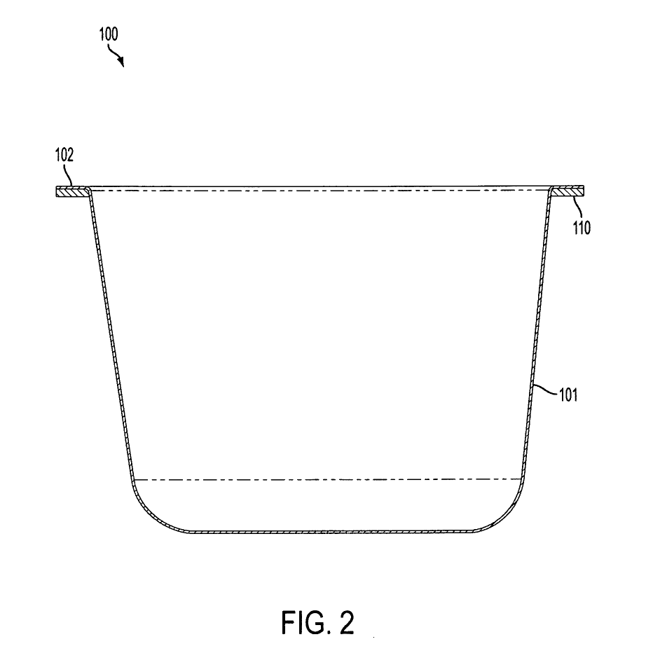

As illustrated in FIG. 2, the container body 101 is provided with a reinforcing ring 110 which has a flat top portion 104 which reinforces the flat top rim 102.

The reinforcement ring 110 may be formed as one piece with the flat top portion in the same plane as the top opening of the container body 101.

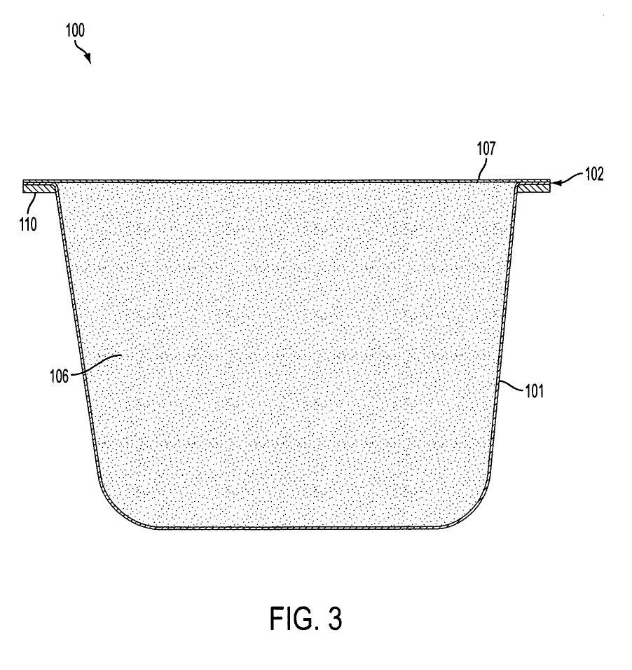

As illustrated in FIG. 3, the ring 110 provides a stiff frame for supporting the container body 101 to receive a closing membrane 107. The ring 110 is connected to the rim of the container body 101 to reinforce the stiffness of the container body 101 and which can provide a circular shaped top opening for the container body 101 to support the closing membrane 107.

In addition, the ring 110 supporting the closing membrane and the rim, the invention provides improved structural stability with a minimum of material. Additional benefits include providing the closing membrane 107 with improved stiffness. Accordingly, the advantageous shape of the ring 110 provides the additional functions and other benefits to the container as well, such as improving the performance of the container to cooperate with a brewing machine by improving a seal that is formed and by providing improved support for the container 100 within the machine, among other things.

The ring 110 can be provided in an approximate shape of a circular ring to suit machines for which the container 100 is adapted for use. It can be appreciated by those skilled in the art, that the ring 110 and body rim 102 can be formed into non-circular shapes such as matching ovals, rectangles or squares.

The ring 110 can be made of oil based plastics or of biodegradable/compostable materials, such as PLA, Mater Bi or blends of biomaterials. The material of the ring 110 is preferably chosen to provide enough rigidity for the design of the rim so that a stiff outer shell cup, such as provided in contemporary designs, is no longer necessary. The flat horizontal ring portion of the ring 110 can facilitate the placement of the container in position in a brewing machine, and facilitate removal of the container after use, which might still be hot and wet. The ring's flat top-horizontal portion also supports and can be sealed to the rim 102 and the barrier film membrane 107 to provide a cover for the container 100. The ring 110 can also be fabricated and shaped to assure a correct positioning of the container in a brewing machine.

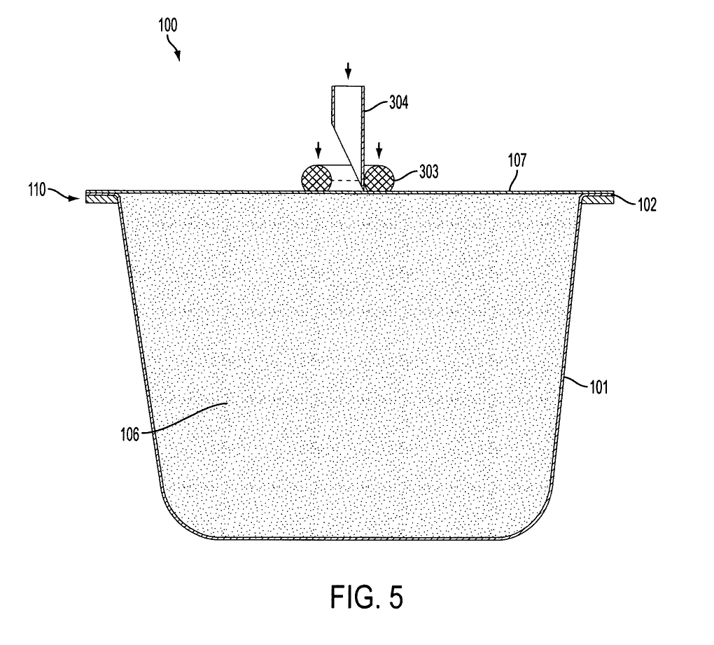

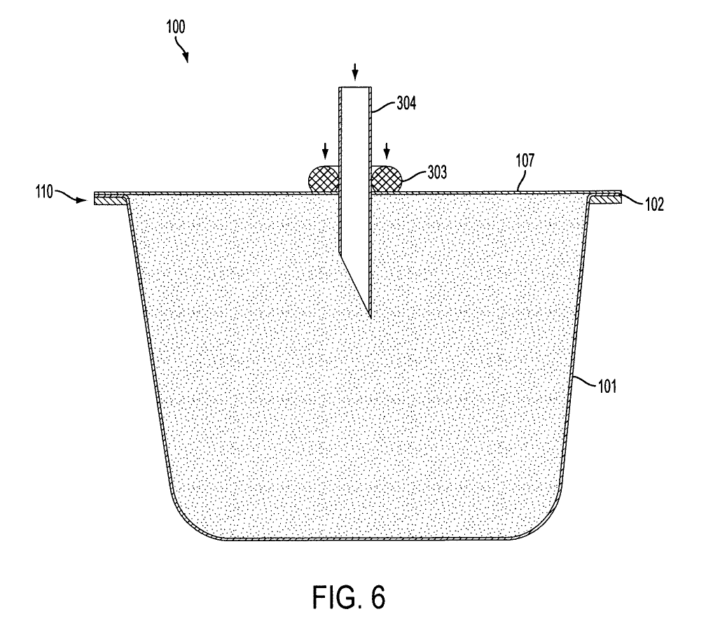

FIG. 3 illustrates an embodiment of a container 100 including the container body 101 with a flat rim 102 and a barrier-film membrane 107. The barrier film membrane 107 provides a top cover to the container 100 and completes the closure of the container 100 after product has been added to the interior space. The barrier film membrane 107 can also provide a surface through which a needle or other device can pierce the membrane 107 to add fluid to the interior space of the container 100 as illustrated in FIGS. 5 and 6. FIG. 6 illustrates the needle 304 after it has pierced the membrane 107. The flat top rim portion 102 of the container body 101 can be connected to the membrane 107 by heat sealing, wherein the material of the rim 102 and membrane 107 can partially meld. The top of the reinforcement ring is heat sealed to the rim 102. For example, the membrane 107 and container body 101 can be formed of materials which include a crossed-fiber mesh. Thus, the membrane 107 and rim 102 of the container body 101 can be caused to meld or melt during fabrication, such as by heat-sealing, to form a strong connection.

During fabrication of an embodiment of a container according to the invention, the reinforcement ring 110 can be heat-sealed to a rim of a container of filterable, thermoformable material. Thereafter the container body can be thermoformed to provide the desired shape and a space within the container to receive a product. The product then can be inserted into the container. After this, the container space can be closed by heat sealing a membrane to the top of the flat rim portion of the container body which can be heat sealed to the reinforcement ring 110.

The membrane 107 can be fabricated from a variety of laminates, bioresins or other biomaterials, thus contributing in making the container biodegradable and/or compostable, and compliant with standards such as ASTM6400. Preferably, the membrane 107 is fabricated from material such that once connected to the container 100 during fabrication, the membrane 107 is rigid and is substantially impermeable to liquids. The benefits of providing a substantially stiff membrane 107 with a ring 110 of improved stiffness includes improved perforation by a needle of a brewing machine.

The container body 101 is preferably made of permeable film to permit fluid to pass through the container. For example, the container body 101 can be formed of a filterable membrane which can be thermoformed into the approximate shape of a cup or pail, or it can be made an oval, rectangle or square shape thereby forming an interior space for receipt of a product.

In addition, the container body 101 can be formed of a single material provided the material can both provide support to contain the product for storage in the interior space and can be permeable to fluid when the container is applied for its intended use in a single serve brewing machine. Filtering, permeable, thermoformable material appropriate for an embodiment of a container body include Smash™, supplied by Asahi Kasei Fibers Corporation, JAPAN. The material for the container body 101 preferably provides excellent filtering features for the containers' intended use while allowing for an optimal extraction of the product, such as ground coffee, tea, cocoa, or milk powder. In addition, the choice of material preferably provides excellent thermoforming features, allowing the material to be formed into a deep container for the dry medium, important for an optimal extraction and infusion. Furthermore, it can be appreciated that the choice of material depends on its intended use and the thickness of the material chosen for such use. For example, the thickness of the material offers different degrees of permeability, allowing variation in the time the dry medium will be in contact with hot water in a brewing machine, before the extraction process has been completed, and thus materials of different thicknesses can be chosen depending on the type of material to be used with the container.

The material of the container body can be chosen to very light and thin and the amount used to form the body chosen so that its percentage within the overall package is less so as to meet the biodegradability and/or compostability requirements of a single serve brewing container, such as according to ASTM6400.

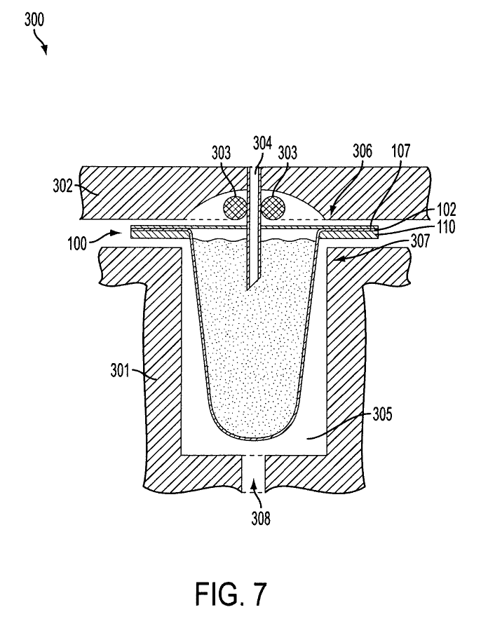

FIG. 7 shows a container according to the invention adapted for use with a machine type 300, such as a coffee maker or other single serve brewing machine for the container illustrated in FIG. 6. The container 100 includes a container body 101, a ring 110, and a barrier-film membrane 107, as described above for FIG. 3 and adapted for use with the machine type 300. The machine includes a container receiving portion 301 for receiving the container 100 and a reservoir 305 for receiving fluid that has passed through the container 100. The container receiving portion 301 includes an exit aperture 308 for providing an outlet for the fluid and/or gas pressure. The container receiving portion 301 has a locking portion 307 which provides a support surface which cooperates with the ring 110 of a container 100. Accordingly, an embodiment of a lid 302 according to the device is preferably adapted to provide a snug fit with the supporting portion 307 of the machine. For example, the ring 110 provides structural support for the container 100 when placed in the machine, and provides a seal by cooperating with the container receiving portion 301 and a lid 302 of the machine 300. The machine has a needle 304 or other means for delivering fluid into the container 100 such as a tube or conduit. The needle 304 is typically part of the lid 302 and can cooperate with the closing of the lid 302 upon the container to pierce the membrane 107 and cooperate with the ring 110 and container receiving portion 301 to form a seal enclosing the container 100.

When closed, the needle punctures the membrane 107 while the gasket 303 forms a seal against the membrane 107 of the container 100. When closed, the needle 304 can introduce pressurized fluid, such as hot water, into the container 100, thereby mixing with the brewing product, such as coffee grounds, in the container 100. Upon mixing of the fluid into the container, the fluid absorbs some of the brewing product and exits the container through the permeable portions of the container body 101, whereafter the fluid can be stored in the reservoir 305 and/or exit through the exit aperture 308.

In view of the above application of a container according to the invention shown in FIG. 6, for example, it can be appreciated that the ring 110 can be provided in a shape and dimension adapted to be received by a machine for which the container 100 is intended to be used. The flat horizontal portion of the reinforcement ring 110 can be provided to form part of the seal with the brewing machine, such as by enclosing the container and applying pressure to the flat horizontal portion of the reinforcement ring 110.

FIG. 6 shows an embodiment of a container 100 according to the invention adapted for use with a machine type 300, such as a coffee maker or other brewing machine. A container 100 according to the invention can provide improved performance when the gasket 303 and the needle 304 are pressed against the barrier-film closing membrane 107. The membrane 107 is stiffened by the integral union of the membrane 107 to the rim of the container 102 and to the reinforcement ring 110, as the needle 304 is pressed against the membrane 107 to pierce the membrane 107 which can maintain an improved seal with the needle 304 and the gasket 303. Arrows are shown in the figure to indicate the direction of force applied by the sealing of the gasket 303 and the piercing of the needle 304. Accordingly, a container 100 according to the invention provides a stiffened membrane 107 which can be perforated by a needle without requiring bulky outer cups or pails.

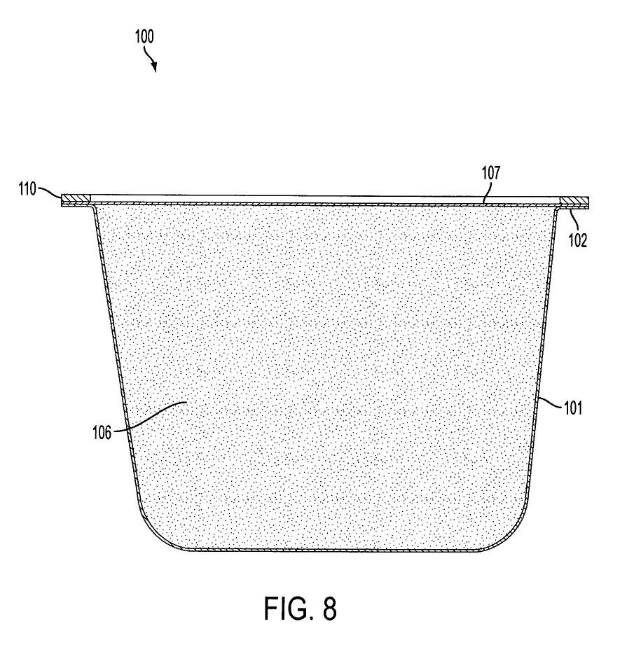

FIG. 8 shows an alternative embodiment of a container 100 according to the invention adapted for use with a machine type 300, such as a coffee maker or other brewing machine. The container 100 includes a container body 101 with a rim 102, a barrier-film membrane 107 and a flat reinforcement ring 110. The reinforcement ring 110 is sealed on the top of the barrier-film membrane 107 proximate its outer edge, which in turn is sealed to the rim 102 of the container 100, forming a stiff integral support for the membrane 107.

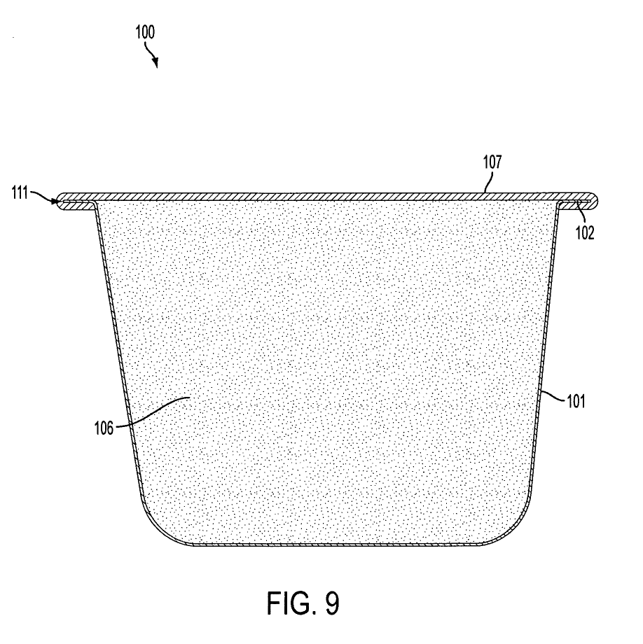

FIG. 9 illustrates another alternative embodiment of a container 100 according to the invention. The container 100 includes a container body 101 and a stiffer thickened barrier-film closing membrane 107 folded about the edge 111 of the rim 102. The reinforcement of the container rim 102 is provided in this case by a higher rigidity thickened and stiffer barrier-film membrane 107 to form the folded edge 111 reinforcement. Reinforcement of the rim is obtained by folding the outer edge of the barrier-film membrane 111 around the flat ring rim 102 of the container 101 as illustrated in FIG. 9. In one embodiment, a portion of the membrane 107 folded around an outer edge of the container body 101 may be infused with resin for adding stiffness to the mesh of the membrane material. Resin can be provided in a liquid form or infused into the overlapping portions of the folded edge of the membrane folded edge 111 and the rim 102 container 101. Accordingly, during fabrication a flat thin ring of reinforcement material can be provided which becomes substantially embedded within the mesh of the rim 102 and membrane 111 during a heat sealing operation. Accordingly, the rigid membrane folded edge 111 provides additional stiffness so the membrane 107 can be pierced by a needle 304.

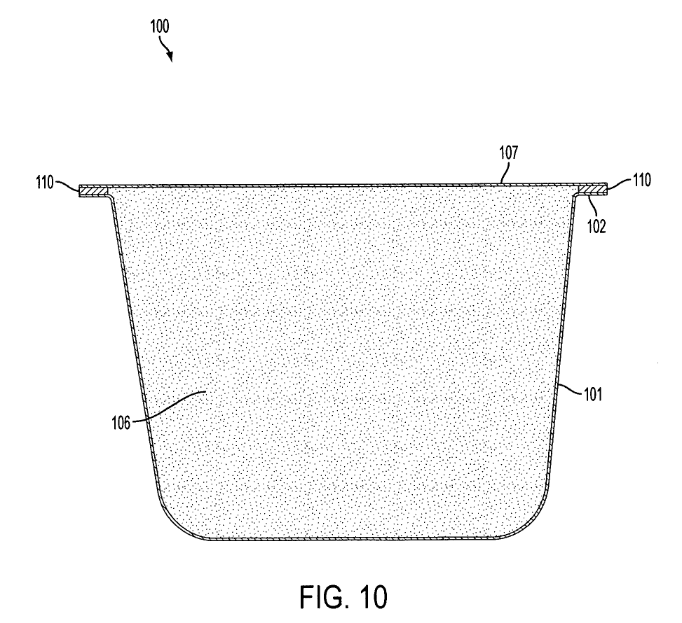

FIG. 10 shows an alternative embodiment of a container 100 according to the invention. The container 100 includes a container body 101, a flat reinforement ring 110, and a barrier-film membrane 107. In this embodiment, the flat reinforcement ring 110 can provide a number of the functions of the reinforcement ring discussed above. The top of ring 110 is sealed on the under side of the outer edge of the barrier-film membrane 107. The underside of the ring 110 is attached to the rim 102 of the container.

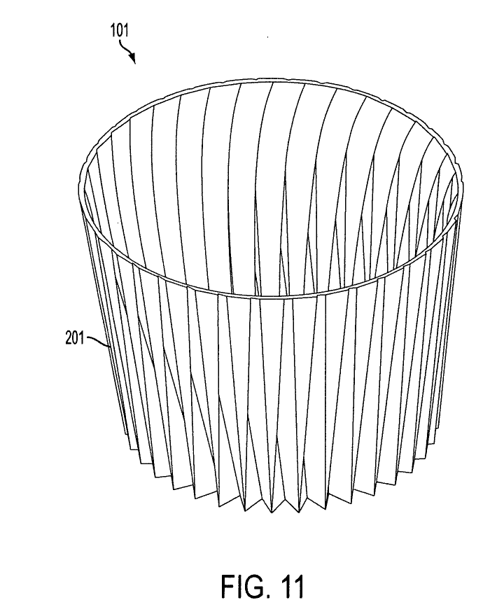

FIG. 11 shows an alternative embodiment of a container body 101 according to the invention. The container body 101 can be provided with pleated portions 201 to provide at least a partially pleated surface. A top portion of the container body 101 can be provided with a substantially flat surface around a perimeter of its top portion to add additional surface area for connection to the reinforcement ring 110. The pleated portions can extend to a lower portion of the container body 101 and thereby stiffen the container body 101. By providing pleated portions, the container body can thereby be stiffened to be substantially self-supporting and thus improve the aesthetic appearance of the container body, its structure and reduce the possibility of being inadvertently squeezed and compressed when being handled by a user.

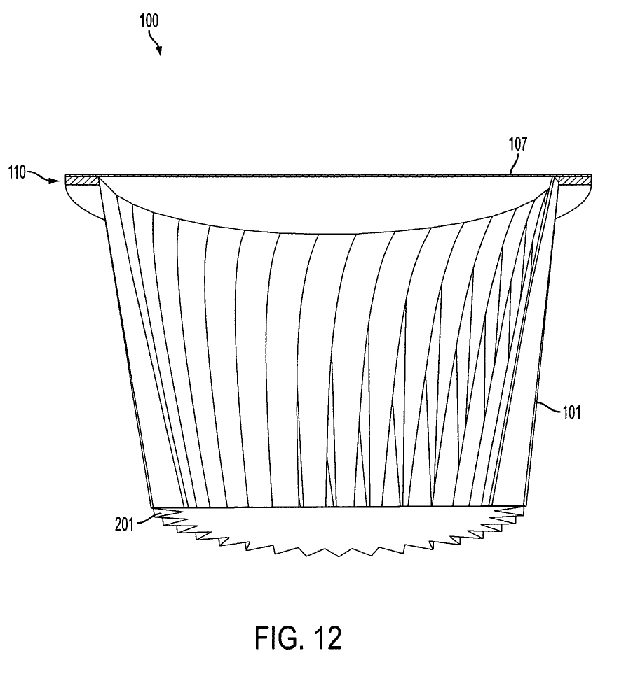

FIG. 12 shows a cross-sectional view of an alternative embodiment of a container 100 according to the invention having a container body 101 with pleated portions 201. A top portion of the container body 101 is provided with a substantially flat rim surface around its perimeter, and can thereby be more effectively connected to a reinforcement ring 110. The pleated portions can extend to a lower portion of the container body 101 and thereby stiffen the container body 101. In addition, the barrier-film closing membrane 107 can be sealed directly on the top, flat horizontal surface of the reinforcement ring 110.

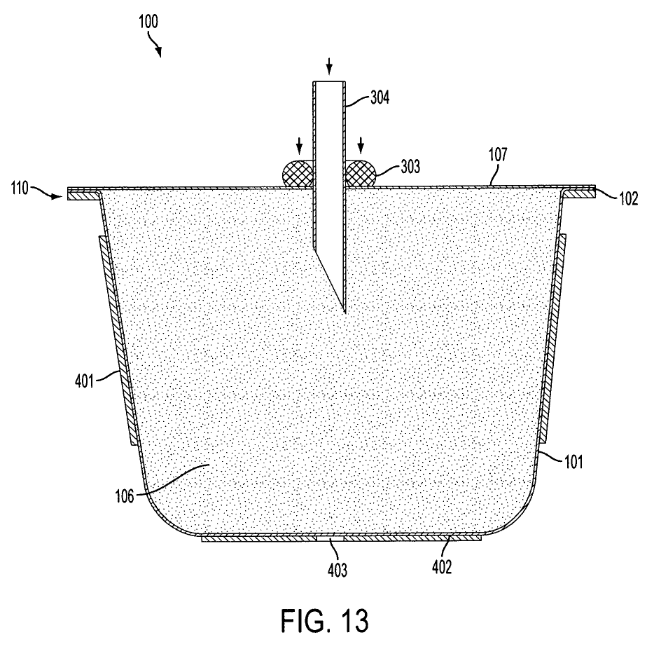

FIG. 13 shows an alternative embodiment of a container 100 according to the invention adapted for use with a machine 300, such as a coffee maker or other brewing machine wherein the needle 304 has pierced the membrane 107. The container 100 includes a container body 101, a reinforcement ring 103 and a barrier-film membrane 107. The container body 101 can be formed from a plurality of materials, such as a less porous material and a more porous material. For example, a sleeve 401 of less porous material can be provided at a top portion of the container body 101 comprising a main material of more porous material so that fluid is disposed to flow through a greater portion of the brewing material before flowing through the more porous material of the container body 101. Preferably, the sleeve permits at least a portion of the fluid to pass through the portion of the container body having the sleeve.

It can be appreciated that the container body comprises a sufficient permeable filtrating surface to let the hot water go through the dry medium and easily flow downwards. For example, it can be appreciated that in one embodiment by varying the porosity of the material, one can affect the strength of the brewed beverage. Accordingly, an embodiment of a container 100 according to the invention having a sleeve 401 can provide a solution for adapting a container according to the tastes of a user. As a further benefit, an embodiment of a container 100 according to the invention having a sleeve 401 can provide a solution for adapting a container having a container body 101 whose main material is too porous to suit the tastes of a user, whereby a sleeve can be provided to reduce the overall porosity if needed.

Accordingly, the container body 101 can be formed with the sleeve overlapping a portion of the more porous material of the container body 101, whereby fluid passes through both the more porous material of container body and the less porous material of the sleeve. Alternatively, the container body 101 can be formed with the sleeve adjoining a portion of the more porous material of the container body 101, whereby fluid can pass through the more porous material of container body and the less porous material of the sleeve separately. In one embodiment, the sleeve can be provided to extend to a distance below where the aperture of a needle is disposed when in use whereby fluid can be caused to flow into brewing material above the level of the aperture of the needle. The sleeve 401 can also overlap a portion of the ring 103, and can be provided on the inside of the container body 101 or outside.

In addition, or in the alternative a spreader disc 402 can be provided. The spreader disc 402 can conform to the shape of a lower portion of the container body 101, such as a disc, and can be fabricated from a less porous material. Accordingly, fluid passing through the brewing material 106 is disposed to fill the container and saturate the brewing material, and can further be disposed to flow through the sides and bottom portion of the container body at a slower rate without requiring additional material of the container body. In addition, the spreader disc 402 can be provided at an outside portion of the container body 101. In an alternative embodiment, the spreader disc 402 can be removable by a user who may desire to have stronger or lighter brewed beverage. In addition, the spreader disc 402 can be removable by a user who may desire to enjoy the aroma of the brewing material on an inside portion of the spreader disc 402, such as while the container 100 is in use in the machine 300. The spreader disc 402 can be provided with an aperture 403 to facilitate flow of fluid through an entirety of the brewing material.

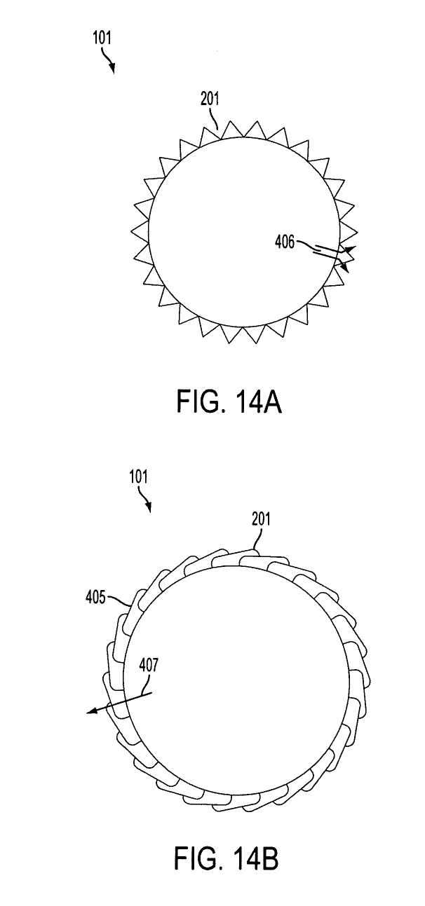

FIG. 14 shows an alternative embodiment of a container body 101 according to the invention, with FIG. 14a showing a cross-section of a lower portion of the container body 101, and FIG. 14b showing an upper portion of the container body 101. The container body 101 can be provided with pleated portions 201 to provide at least a partially pleated surface at the lower portion and can provide fluid flow 406 through each side of a pleated portion 201 separately. A top portion of the container body 101 can be provided with pleated portions 201 that have been flatted against one another to form a substantially flat surface around a perimeter of the top portion of the container body 101, and can thereby be more effectively connected to a ring 103 of a container 100. In addition, the overlapping portions can provide reduced fluid flow 407 through each overlap portion 405 of the pleated areas 201 of the container body 101. By providing overlapping pleated portions 201, the container body 101 can thereby promote fluid flow throughout an entire column of brewing material in the container body by reducing the flow out of the container at a top portion of the container while utilizing a container body 101 that can be fabricated from a single piece of material. It can be appreciated by a person of ordinary skill in the art to choose a material for the container body 101 having sufficient porosity to permit sufficient flow of fluid though the product and container body 101 so that a brewed product can be produced having a desired strength using the container 100 with existing brewing machines.

The invention may be accomplished in various manners concerning dimensions, structure and materials used for making different reinforcements and how to make them integral with the container. For example, the membrane can be provided with additional thickness to provide for additional rigidity.

Now that the original innovative characteristics of the present invention have been disclosed, anyone with average technical expertise in this specific technological field shall be capable of making thermoformed filtering permeable or filter paper containers, improved by stiffening the structure without much inventive effort, but with simple logic and technical deductions, having the basic features been described, and illustrated in the following claims.

1. A filtering container for water soluble beverage making products, comprising:
a water permeable container body thermoformed from a flat film providing a container space to receive a water soluble brewing product, the container body having a flat rim extending around the opening of the container;
a reinforcement with a horizontal portion that mates with and reinforces the flat rim of the container body with a substantially flat surface which forms a complementary support, and wherein the flat rim of the container is connected to membrane that closes the opening of the container and maintains the membrane in a substantially stiff manner.

2. A filtering container according to claim 1, wherein the reinforcement is a flat ring which reinforces the undersurface of the rim.

3. A filtering container of claim 2 wherein the membrane is connected to the top side of the flat rim and the underlying flat ring supports the rim.

4. A filtering container according to claim 3 where the ring is circular and is approximately the same diameter and width as the rim.

5. A filtering container for water soluble beverage making products, comprising:
a water permeable cup shaped container body thermoformed from a flat film providing container space to receive a water soluble brewing product, the container body having a narrow circular flat rim extending around the opening of the container;
a reinforcement ring that reinforces and supports the flat rim of the container body with a substantially flat upper surface which mates and forms a reinforcement for the underside of the rim,
a membrane is connected to the top side of the flat rim that closes the opening of the container and maintains the membrane in a substantially stiff manner.

6. A filtering container according to claim 5, wherein the reinforcement ring has a diameter and width which matches the narrow width and diameter of the rim.

7. A filtering container for water soluble beverage making products, comprising:
a water permeable container body thermoformed from a flat film providing container space to receive a water soluble brewing product, the container body having a flat rim extending around the opening of the container;
a membrane that closes the opening of the container, the membrane being attached at its periphery to the top of a rim of the container body;
a reinforcement ring with a horizontal under portion that mates with the top side of the periphery of the membrane and supports the top side of the flat rim of the container body.

8. A filtering container according to claim 1, wherein the horizontal portion of the reinforcement has a bottom surface and wherein the membrane is folded around an outer edge of the rim and is connected to at least a portion of a bottom surface of the reinforcement.

9. A filtering container according to claims 1 and 4, wherein the container body includes pleated portions whereby the container body is stiffened to be substantially self-supporting.

10. A filtering container according to claim 4, wherein the container body further comprises a sleeve, wherein the sleeve cooperates with the container body to provide a lesser permeable portion of the container body.

11. A filtering container according to claim 5, wherein the container body further comprises a spreader disc disposed at a bottom center portion of the container body, wherein the spreader disc cooperates with the container body to provide a lesser permeable portion of the container body.

12. A filtering container according to claim 5, wherein the spreader disc is disposed on an outside surface of the container body and is removable.

13. A filtering container according to claim 12, wherein the spreader disc further comprises a spreader disc aperture disposed at a center portion of the spreader disc.

14. A filtering container according to claim 7, further comprising a resin and a overlapping portion where the membrane overlaps the rim, and wherein the resin, membrane and rim are heat-sealed whereby the membrane is supported in a substantially stiff manner.
